(19) United States
(12) Patent Application Publication
(10) Pub. No.: US 2016/0042582 A1
(43) Pub. Date: Feb. 11, 2016

(54) ELECTRONIC LOCKING SYSTEM

(71) Applicant: RPH Engineering, Lehi, UT (US)

(72) Inventors: Ryan P. Hyde, Lehi, UT (US); Jacob S. Morrise, Lehi, UT (US); John Robert Schwartz, Saratoga Springs, UT (US); Michael R. Colton, American Fork, UT (US); Neal Taylor Tew, Lehi, UT (US)

(21) Appl. No.: 14/821,726

(22) Filed: Aug. 8, 2015

Related U.S. Application Data
(60) Provisional application No. 62/034,942, filed on Aug. 8, 2014.
(60) Provisional application No. 62/105,166, filed on Jan. 19, 2015.
(60) Provisional application No. 62/105,206, filed on Jan. 20, 2015.
(60) Provisional application No. 62/131,320, filed on Mar. 11, 2015.

(51) Int. Cl. G07C 9/00; G06K 7/10; G01S 19/13; E05B 47/00; E05B 67/06

(52) U.S. Cl. CPC G07C 9/00944; E05B 47/0001; E05B 67/06; G01S 19/13; G07C 9/00182; G07C 9/00817; G07C 9/00571; G06K 7/10356

(57) ABSTRACT

A lock, such as a padlock or a door lock, having radio frequency identification (RFID) and/or Bluetooth capabilities is disclosed. The control system in the lock may obtain identifying information from a user device presented close to the lock, and operates an actuator to unlock the lock based on the identifying information. The lock may include both an RFID reader and a Bluetooth system in a single device, and may automatically lock and unlock the lock by detecting a presence or an absence of a user device near the lock. At least a portion of a front face of the lock may be made of non-metallic material. The lock may include an indicator for indicating a power-on state, a Bluetooth connection status, a locked or unlocked status, and/or a low-battery state.

### CLAIM OF PRIORITY

This application claims priority to U.S. Provisional Application Nos. 62/034,942, filed Aug. 8, 2014; 62/105,166, filed Jan. 19, 2015; 62/105,206, filed Jan. 20, 2015; and 62/131,320, filed Mar. 11, 2015, which are incorporated herein by reference as if fully set forth.

### TECHNICAL FIELD

This application is related to an electronic locking system. More particularly, this application is related to a lock, such as a padlock or a door lock, having a radio frequency identification (RFID) and/or Bluetooth capability.

### BACKGROUND

An electronic door lock may be accessed, for example, with a magnetic strip key card, a smart card, or a proximity badge, or by using a personal identification number, or the like. Typically the lock includes a card reader into which a key card or a smart card can be inserted. The key card and the smart card include a magnetic strip that stores a code or other access information that is read by the electronic lock. The keycard “KEY” may also be a card that has an imbedded RFID chip. If the code on the key card or the smart card matches predefined criteria, the electronic lock will operate the door latch to allow access to the area secured by the lock.

### SUMMARY

An electronic lock, such as a padlock or a door lock, having RFID and/or Bluetooth capabilities is disclosed. The control system included in the lock may obtain identifying information from a user device, such as an RFID device or a Bluetooth device, presented close to the lock, and operates an actuator to unlock the lock based on the identifying information. The control system may also operate the actuator based on time-based information, Global Positioning System (GPS)-based information, and/or customized access grant criteria programmed by the user based on specific-use case conditions. The lock may include both an RFID reader and a Bluetooth system in a single device, and may automatically lock and unlock the lock by detecting a presence or an absence of a user device near the lock.

The lock includes a housing, a locking mechanism for locking the lock, and a lock control system including an RFID reader, a Bluetooth system, and a processor. The lock may also include other bi-directional communication sub-systems such as Z-wave, WiFi, or radio frequency (RF) communication protocols. The lock control system is configured to actuate the locking mechanism based on identifying information obtained via the RFID reader or the Bluetooth system.

At least a portion of a front face of the housing of the lock in front of an RFID antenna and a Bluetooth antenna may be made of non-metallic material. A non-metallic isolation may be provided between a wrap-around body and a bottom plate of the housing of the lock.

An RFID circuitry and a Bluetooth circuitry are printed on a printed circuit board (PCB), and a ground plane provided for the RFID circuitry and the Bluetooth circuitry may have a slot where an RFID antenna and a Bluetooth antenna are located. A cutout may be provided on a front plate of the housing, leaving an RFID antenna and a Bluetooth antenna exposed.

The lock may be a padlock including a shackle and a housing. The housing may include a dowel pin channel for accommodating a dowel pin attached around a bottom of the shackle, wherein the dowel pin channel is extended vertically with a horizontal extension at a top of the dowel pin channel such that the shackle can move vertically freely but cannot swivel until the shackle is fully extended out of the housing.

The lock may include a sensor to provide a signal to the processor that the shackle is in the closed and locked position.

The lock may include a data connector, such as a micro Universal Serial Bus (USB) connector, for connecting to an external entity. The data connector may be accessed through a channel formed in the housing.

The locking mechanism may include a servo motor and a metal pin drivable by the servo motor. The metal pin may be inserted into a notch formed into a shackle when in a locked state, and retracted from the notch when in an unlocked state.

The lock may include an indicator (e.g., light-emitting diodes (LEDs)) for indicating at least one of a power-on state, a Bluetooth connection status, a locked or unlocked status, a low-battery state, or the like.

The lock may be a door lock including an external unit and an internal unit installed outside and inside a door, respectively. The external unit includes an external handle and the internal unit includes an internal handle. The locking mechanism may include a servo motor and a metal pin drivable by the servo motor. The metal pin may be driven into a locking hole formed into the external handle in a locked state to prevent the external handle from rotating, and the metal pin may be extracted from the locking hole in an unlocked state.

The external handle and/or the internal handle may be a two-part assembly including a hand-gripping part and a plate rotatably attached to the external unit or the internal unit. The hand-gripping part is attached to the plate with two screws such that the screws break before any other components of the lock break when an excessive force is applied to the hand-gripping part.

The lock may include a decoupling means configured to allow the internal handle to turn and open the door without operating the external handle. The lock may include an automatic back unlock means configured to detect operation of the internal handle to unlock the door and leave the door unlocked. The lock may include a door lock turning prevention means for allowing the external handle to rotate in a specific direction.

The lock may stay in a sleep state until a button on a front plate of the lock is pressed by a user and returns to the sleep state after use or a predetermined period of inactivity. The lock may be configured to wake up periodically in order to communicate and receive instructions from the user (e.g., via Bluetooth, WiFi, or any other means).

The lock may include a memory to store identifying information of users that opened the lock, and time and date information that the lock was opened. The lock control system may be configured to automatically unlock and lock the lock by detecting a presence or an absence of an RFID device or a Bluetooth device within a range of the lock.

The lock may include a door proximity sensor to determine if the door is in the open or closed position.

The lock control system may be configured to maintain a list of Bluetooth-enabled devices that it has previously connected to, and establish a connection with a Bluetooth-enabled device based on the list.

The lock may include a GPS module to determine a geolocation of the lock. The lock may be programmed to open or remain closed inside a specific geolocation. The lock-opening credentials may be based on time or location.

The locking system may include a fixed “master access code” programmed in the lock firmware that may not be erased or changed via Bluetooth or RFID. The locking system may be set up to allow administrator credentials via a particular protocol. The lock may be set up such that the first RFID code scanned by the lock may become the master authorizing credential.

The lock may be set up such that after scanning an authorized card or receiving an authorized command via RF communication, the program button may be pressed or appropriate credentials may be sent via RF communication means to restore all factory default settings on the lock.

The lock may be set up such that after scanning an authorized card or receiving an authorized command via RF communication, the program button may be pressed or appropriate credentials may be sent via RF communication means to customize the authorization credentials.

The lock may be programmed to read one key or any number of keys.

The lock may be configured to read one or several standard near field communication (NFC) protocols simultaneously depending upon user preference and/or available memory space.

The lock may include a real time clock (RTC) configured to keep time and date information. The lock control system may be configured to keep records of identification of a device used to open the lock and time and date information when the lock is opened, and provide the records to a user or owner of the lock. The lock control system may be configured to provide time-based access to a location secured by the lock.

The lock may further include a bolt that is spring-loaded in an open state and released in response to a signal sent from the lock control system to lock the lock.

### BRIEF DESCRIPTION OF THE DRAWINGS

FIG. 1 is a block diagram of an exemplary lock including a control system of a lock in accordance with one embodiment.

FIG. 2 shows an exemplary padlock with a non-metallic face in accordance with one embodiment.

FIG. 3 shows an exemplary padlock with an isolation plate.

FIG. 4 shows an exemplary board with a slotted ground plane in accordance with one embodiment.

FIG. 5 shows an exemplary padlock with a front cover.

FIGS. 6A and 6B show front and rear sides of another type of padlock, respectively.

FIG. 7 shows an exemplary padlock with a front cover removed showing the inside of the padlock.

FIG. 8 shows an inside of an exemplary padlock having a dowel pin and a dowel pin channel.

FIG. 9 shows a back side of an exemplary padlock having a servo motor and a locking mechanism.

FIG. 10 shows an exemplary padlock having a micro USB connector and a channel.

FIG. 11 shows an exemplary padlock with LED indicators on the front cover of the padlock.

FIGS. 12A and 12B show an exemplary door lock seen from an external side and an internal side, respectively.

FIG. 12C shows a Z-wave/WiFi printed circuit board antenna (PCBA) and a cover.

FIG. 12D shows a Z-wave/WiFi antenna cover.

FIG. 12E shows a mounting of a Z-wave/WiFi PCBA and a cover.

FIG. 12F shows a Z-wave/WiFi PCBA with the cover removed.

FIG. 13 shows an exemplary door lock with a front cover removed showing an inside of the door lock in accordance with one embodiment.

FIG. 14 shows an opening in a door handle of a door lock.

FIG. 15 shows an exemplary two-part assembly of the external and internal handles of the door lock.

FIG. 16 shows a lock pin for locking the external handle.

FIG. 17A shows a handle decoupling feature of the door lock.

FIG. 17B shows a handle decoupling feature in accordance with another embodiment that allows for both left- and right-handed door opening.

FIG. 18 shows an exemplary door lock with a door lock switch and a cam for automatic back unlock.

FIG. 19A shows a battery tray inserted into the door lock.

FIG. 19B shows a battery tray slid out of the door lock.

FIG. 20 shows an exemplary door lock handle turning prevention feature of a door lock.

FIG. 21 shows the inside of the external unit of the door lock seen from the back side of the external unit.

FIGS. 22A and 22B show external and internal units of an exemplary door lock with LED indicators, respectively.

### DETAILED DESCRIPTION

Embodiments hereafter will be explained with reference to a padlock and a door lock. However, it should be noted that the embodiments disclosed herein can be applied to any types of locks. For example, embodiments disclosed herein can be applied to a padlock, a deadbolt door lock, a sliding door lock, a display case lock, a computer security lock, or any types of locks.

In accordance with an embodiment, a lock, such as a padlock or a door lock, has RFID/near field communication (NFC) and/or Bluetooth capabilities. The control system in the lock is capable of obtaining identifying information of a user device (such as an RFID/NFC device or a Bluetooth device) that is presented close to the lock. If the identifying information of the user device indicates that the holder of the user device is authorized to access the area secured by the lock, the control system operates the actuator to unlock the lock.

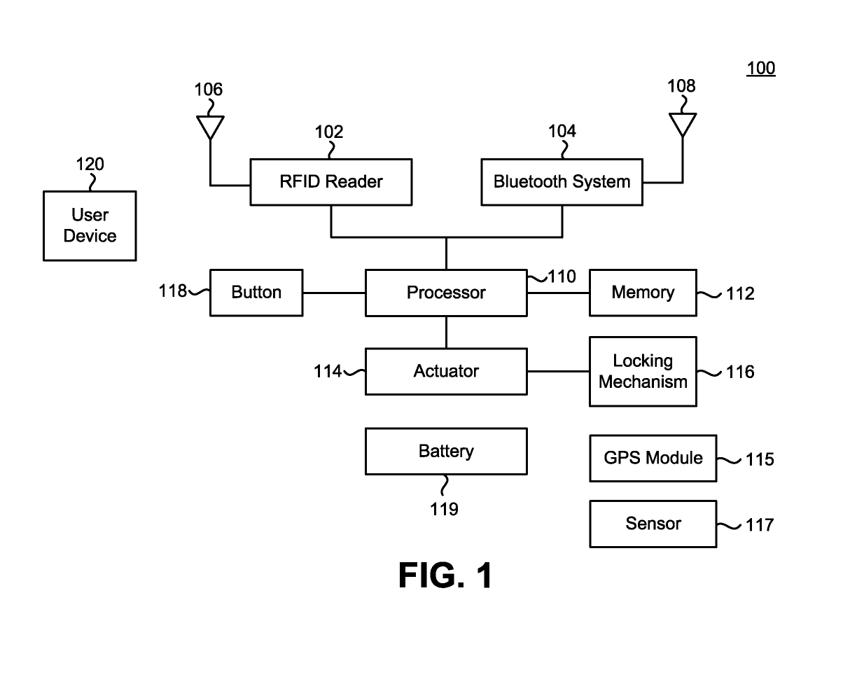

FIG. 1 is a block diagram of an exemplary lock 100 including a control system of a lock in accordance with one embodiment. The lock 100 may include an RFID reader 102, a Bluetooth system 104, an RFID antenna 106, a Bluetooth antenna 108, a processor 110, a memory 112, an actuator 114, a GPS module 115, a locking mechanism 116, a sensor 117, and/or a button 118. It should be noted that the RFID capability and the Bluetooth capability are used herein as examples of short-range wireless communications, and any other similar short-range wireless communication technologies may be used. For example, the RFID reader and device may be replaced with an NFC reader and device, and any other wireless local area communication protocols other than Bluetooth may also be used.

A lock 100 may be provided with a button 118 on a front face of the lock 100. When a user (i.e., a holder of a user device 120 (e.g., an RFID device or a Bluetooth device)) presses the button 118, an input signal is sent to the processor 110. Upon receipt of the input signal, the processor 110 sends an activation signal to the RFID reader 102 or the Bluetooth system 104. The RFID reader 102 or the Bluetooth system 104 then searches for the user device 120 for obtaining identifying information from the user device 120. The identifying information may be obtained from the user device 120 in accordance with a conventional process or protocol known in the art. For example, in response to the activation by the processor 110, the RFID reader 102 may emit an RF signal via the RFID antenna 106 to an RFID device, and obtain information back from the RFID device in response to the RF signal.

The user device 120 may be an RFID tag, an NFC tag, a smart card, or the like, or may be an NFC-enabled or Bluetooth-capable phone or hand-held computing device, or a smart phone or any hand-held computing device functioning as an RFID tag or an NFC tag.

The RFID reader 102 or the Bluetooth system 104 then sends the identifying information obtained from the user device 120 to the processor 110. The processor 110 determines whether the holder of the user device 120 is authorized to access the area secured by the lock 100 by comparing the received information to the information stored in the memory 112 of the lock 100. If it is determined that the holder of the user device 120 is an authorized person, the processor 110 sends a signal to the actuator 114 to operate the locking mechanism 116 to unlock the lock 100.

As shown in FIG. 1, the lock 100 may include both the RFID reader 102 and the Bluetooth system 104 in a single device, and either of them may be used to operate the mechanical locking mechanism 116 inside the lock 100 by using an RFID/NFC key or a Bluetooth-enabled device. The battery 119 provides power to the components of the lock 100 including the RFID reader 102, the Bluetooth system 104, the processor, 110, the actuator 114, the locking mechanism 116, etc. The lock 100 may include a GPS module 115 to provide location information to the processor 110 regarding a geolocation of the lock 100. The lock 100 may operate based on the geolocation obtained from the GPS module 115. For example, the lock 100 may be programmed to open or remain closed in a specific geolocation. The lock-opening credentials may be based on both time and location. The lock 100 may include a sensor 117 to provide a signal to the processor 110 indicating that the locking mechanism 116 is in a locked position. The configuration shown in FIG. 1 is applicable to any embodiments of a lock disclosed herein.

A lock 100 is typically made of metal. Placing an RFID reader 102 in close proximity to, or surrounding it by, metal reduces its reading range and may completely disrupt its operation. This occurs because eddy currents are induced in the metal by the alternating magnetic field of the RFID reader 102. Eddy currents are currents induced in conductors to oppose the change in flux that generated them. The eddy currents are caused when a conductor is exposed to a changing magnetic field due to relative motion of the field source and conductor, or due to variations of the field with time. The eddy currents result in ohmic losses as heat and also generate opposing magnetic fields that cancel a portion of the RFID reader field.

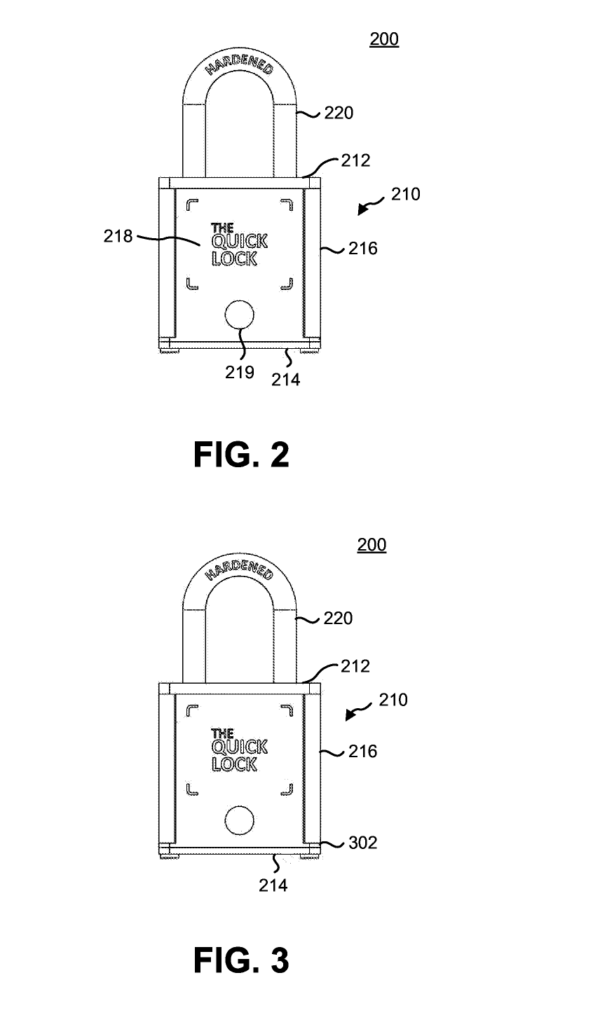

FIG. 2 shows an exemplary padlock with a non-metallic face in accordance with one embodiment. The padlock 200 includes a housing 210 and a shackle 220. The housing 210 may include a top plate 212, a bottom plate 214, a wrap-around body 216, and a non-metallic front plate 218. The wrap-around body 216 has an internal cavity for accommodating internal components of the padlock 200, including the lock control system and the locking mechanism 116. The RFID reader 102 and the Bluetooth system 104 are installed on a PCB (not shown), which is installed in the cavity behind the non-metallic front plate 218. The wrap-around body 216, the top plate 212, and the bottom plate 214 are made out of metal, but the front plate 218 is made out of non-metallic material, for example, plastic, ceramic, stone, or any other non-metallic material. This helps the RFID reader 102 and the Bluetooth system 104 installed on the PCB behind the front plate 218 work properly.

It should be noted that the padlock 200 shown in FIG. 2 is provided as an example, not as a limitation, and the padlock 200 may be in different shapes. In addition, components other than the front plate 218 that are located in front of, and/or behind, the RFID reader 102 and the Bluetooth system 104 may also be non-metallic material. The front plate 218 may be constructed of high-strength non-metallic material to ensure proper protection of the padlock 200.

FIG. 3 shows an exemplary padlock with an isolation plate 302. In order to disrupt the eddy currents and ensure performance of the RFID reader 102 and the Bluetooth system 104 included in the padlock 200, the padlock 200 may have a complete break in the metal parts where the RFID reader 102 and the Bluetooth system 104 are positioned. FIG. 3 shows an isolation plate 302 between the wrap-around body 216 and the bottom plate 214. The isolation plate may also be provided between the wrap-around body 216 and the top plate 212. The isolation plate 302, which separates the metal parts, may be non-metallic material, such as plastic, ceramic, stone, or any other non-metallic material.

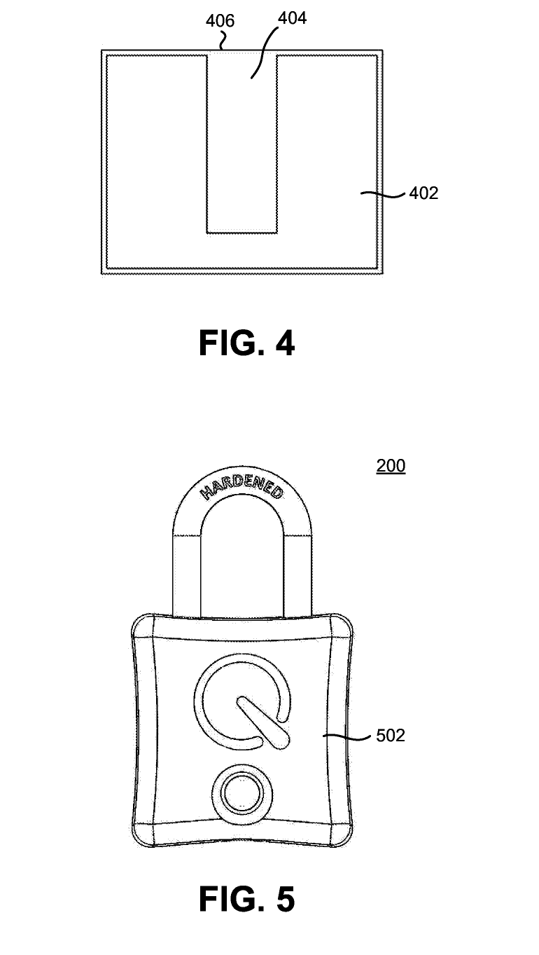

FIG. 4 shows an exemplary board with a slotted ground plane in accordance with one embodiment. A solid sheet of metal behind the RFID antenna 106 or the Bluetooth antenna 108 can reduce the range of the antennas. The RFID circuitry or the Bluetooth circuitry printed on a PCB needs a ground plane. In order to allow for the ground plane without reducing the range of the antenna significantly, a slot 404 may be formed in the ground plane 402 on the PCB 406 as shown in FIG. 4. The slotted ground plane 402 may be formed on one side of the PCB 406, and the RFID circuitry and the Bluetooth circuitry including the RFID antenna 106 and the Bluetooth antenna 108 may be formed on the other side of the PCB 406. The slot 404 is formed in the location that the RFID and Bluetooth antenna are formed.

The internal components of the padlock 200, such as the processor 110, the memory 112, the actuator 114, the RFID reader 102, the Bluetooth system 104, etc., may be powered by a battery 119. In order to lower the power consumption of the battery 119, the padlock 200 may transition between a sleep state (i.e., a low-power state) and an active state. The padlock 200 may stay in the sleep state until the button 219 on the front plate of the padlock 200 is pressed, which activates the internal components of the lock 100. The padlock 200 may be configured to wake up periodically or based on certain triggers in order to communicate and receive instructions from the user (e.g., via Bluetooth, WiFi, or any other means).

As explained above, a user may press the button 219 on the front face of the padlock 200 to access the padlock 200. Once the button 219 is pressed, the processor 110 may transition from the sleep state to the active state and power may be supplied to the components of the padlock 200 including the RFID reader 102 and the Bluetooth system 104. The power may remain available for a specified period of time, after which the power is removed. In one embodiment, once the control system of the padlock 200 is activated, the padlock 200 may make a wireless connection (e.g., using the Bluetooth system 104) to a hub or a server and transmit data stored in the memory 112 to the hub or server.

The authorization information (e.g., identifying information of authorized devices) may be stored in the memory 112 of the lock 100 so that the processor 110 may determine whether the holder of the user device 120 (e.g., an RFID device or a Bluetooth device) is an authorized person based on the information stored locally. Alternatively, a separate module may be used to authorize the user device 120 to work with the lock 100. The authorization information may be stored in a separate server, and may be downloaded to the lock 100 from the server. When the lock 100 is powered on, the lock 100 may update the authorization information from the server. This can allow information transfer without significantly increasing the battery usage.

FIG. 5 shows an exemplary padlock with a front cover. For cosmetic reasons, a cover 502 may be installed over the padlock 200. The cover 502 may be made of non-metallic material. With a cover 502, the padlock 200 may maintain the mechanical strength while providing a potentially better aesthetic appearance.

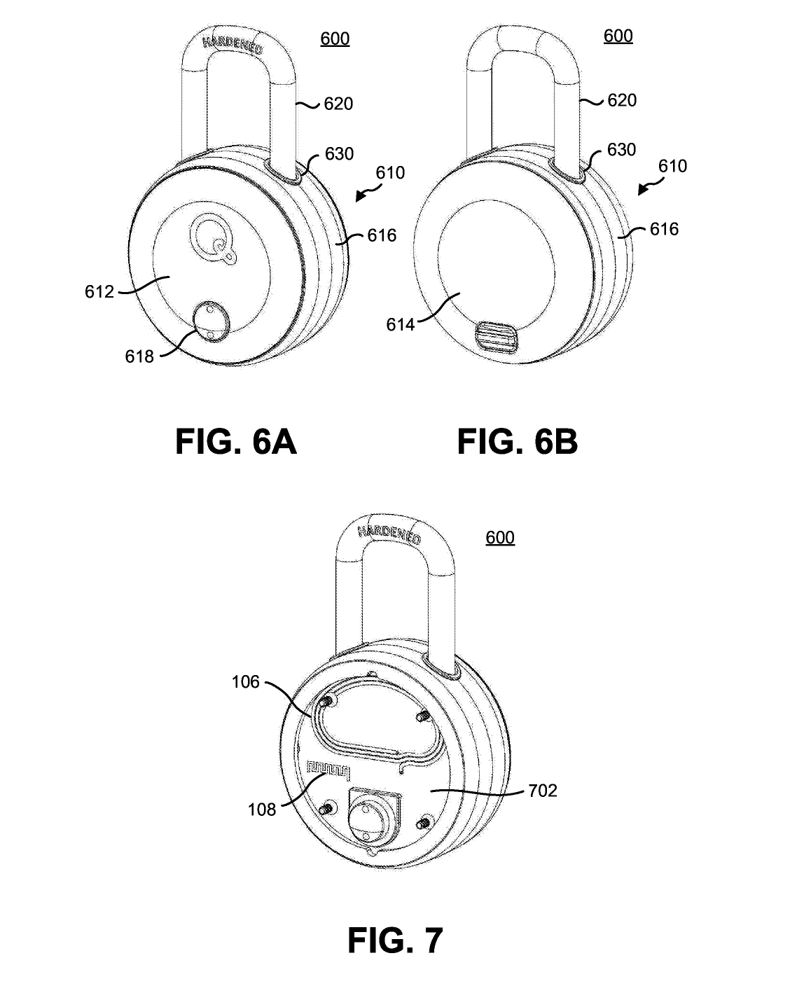

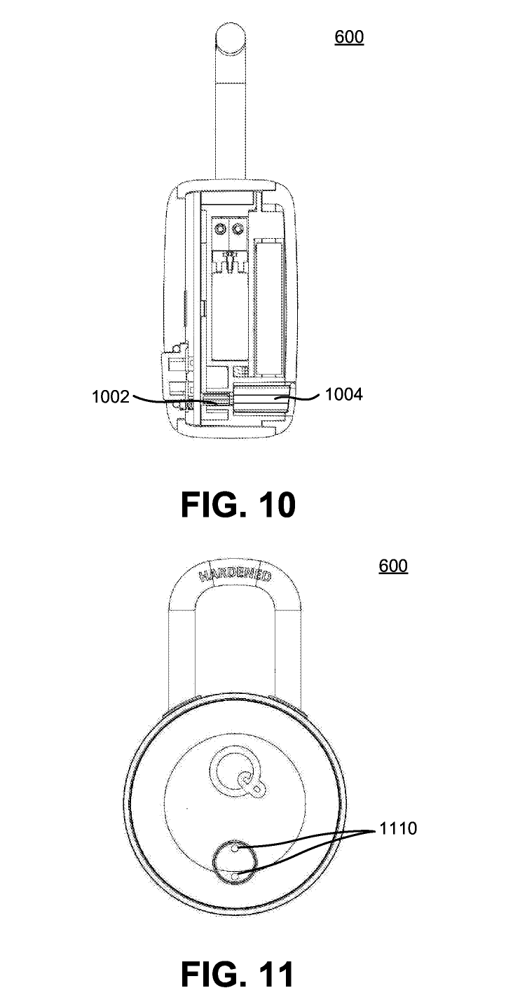

FIGS. 6A and 6B show front and rear sides of another type of padlock, respectively. The padlock 600 includes a housing 610 and a shackle 620. The shackle 620 is made of a hardened material and is inserted into the housing 610 to be locked. The shackle 620 may be inserted into the housing 610 through a gasket 630 for weather resistance. The shackle 620 may be locked in the housing 610 by a locking mechanism 116 to keep the shackle 620 from being removed from the padlock 600, which will be explained in detail with reference to FIG. 10. The housing 610 of the exemplary padlock 600 includes a front cover 612, a rear cover 614, and a body 616 with a cavity inside.

FIG. 7 shows an exemplary padlock 600 with a front cover removed showing the inside of the padlock 600. A PCB having an RFID antenna 106, a Bluetooth antenna 108, and other components disclosed in FIG. 1 is installed in the housing 610. In order to allow a Bluetooth signal or an RFID signal to pass through the metal housing 610 of the padlock 600, a cutout 702 may be formed in the front plate as shown in FIG. 7. The cutout 702 leaves the Bluetooth antenna 108 and the RFID antenna 106 on the PCB exposed. The cutout 702 may be covered by a plastic or any non-metallic cover to protect the PCB and other internal components of the padlock 600, and for a better aesthetic appearance of the padlock 600. FIG. 7 shows that the entire front face is cut out, but a partial cutout may be formed to expose a limited area of the front face of the padlock 600.

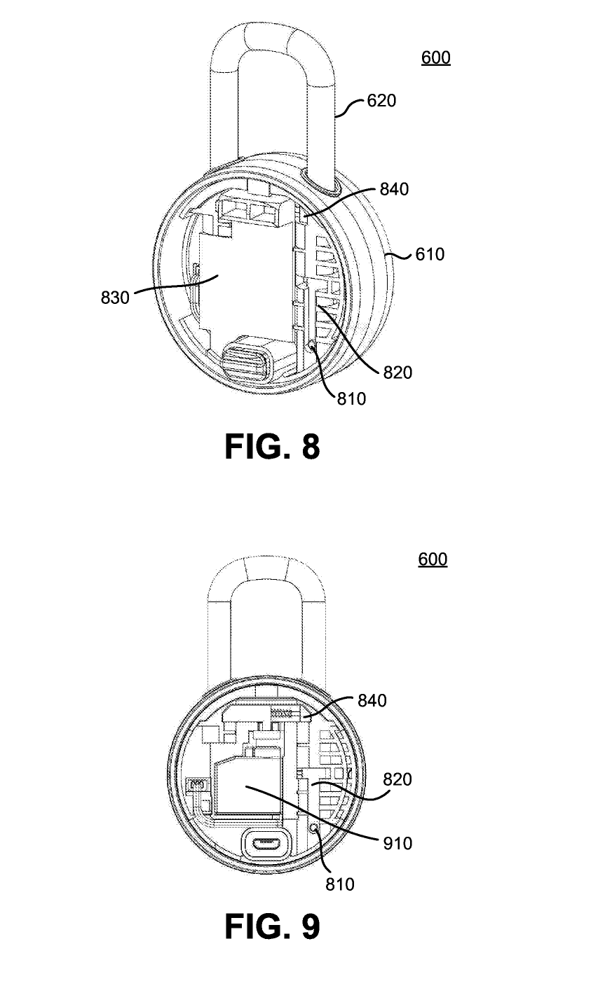

FIG. 8 shows an inside of an exemplary padlock having a dowel pin and a dowel pin channel. The shackle 620 is inserted into the housing 610 in a locked state and may be extended out of the housing 610 in an unlocked state. A dowel pin 810 is installed near the bottom of the shackle 620. The padlock 600 includes a dowel pin channel 820 extended vertically with a horizontal extension at the top of the dowel pin channel 820. The dowel pin 810 is accommodated in the dowel pin channel 820 such that the shackle 620 with the dowel pin 810 may move freely up and down but may not swivel until the shackle 620 is fully extended upward out of the housing 610. The shackle 620 may swivel freely after the shackle 620 is fully extended upward from the padlock 600.

FIG. 8 also shows a back plate 830 and a lock slide 840. The padlock 600 may be designed to allow the lock slide 840 to be installed from the back of the padlock 600 and then be secured into place by the back plate 830.

FIG. 9 shows a back side of an exemplary padlock having a servo motor and a locking mechanism. The padlock 600 may have a servo motor 910 to operate the locking mechanism to unlock and lock the shackle 620 in place. For example, when the padlock 600 is in a locked state, a lock slide 840 is forced, for example by a spring, to be inserted into a notch formed into the shackle 620 such that the shackle 620 may not move freely upward. The lock slide 840 may be automatically engaged with the notch without force by the servo motor by merely pushing the shackle 620 downward into the housing 610. If the processor 110 determines that the holder of the user device 120 is an authorized person, the processor 110 may activate the servo motor 910 to retract the lock slide 840 from the notch so that the shackle 620 may move upward freely.

FIG. 10 shows an exemplary padlock having a micro USB connector and a channel. The padlock 600 may include a micro USB connector 1002 for data connection with an external entity. The micro USB connector 1002 may be installed deep inside the padlock 600 on the PCB. A user may connect a matching connector (e.g., a micro USB connector) to the micro USB connector 1002 through the channel 1004. The channel 1004 allows a micro USB connector to be plugged in deep inside the padlock 600. This helps prevent any excess force applied to the matching micro USB connector from causing the micro USB connector 1002 to break the PCB. A plug (e.g., a rubber plug) may be inserted into the channel 1004 to protect the micro USB connector 1002 with weather resistance. It should be noted that a micro USB connector is provided as an example, and the padlock 600 may include any type of data/power connector.

As shown in FIG. 1, the padlock 600 may have a GPS module 115 to provide location information to the processor 110 regarding a geolocation of the padlock 600.

As shown in FIG. 1, the padlock 600 may have an internal memory 112 to store data. The padlock 600 may store information regarding the users that opened the lock, the time and date that the lock was opened and/or closed, and any other relevant information. The padlock 600 may have an application running on the processor 110. The application may store the user and time/date/location information when a lock is opened and/or closed as well as any other information. The data stored in the memory 112 may be transferred to a server or any external entity via a wireless connection (e.g., using the Bluetooth system 104) or a wired connection (e.g., using the micro USB connector 1002).

As described above, the internal components of the padlock 600, such as the processor 110, the memory 112, the actuator 114, the RFID reader 102, the Bluetooth system 104, etc., may be powered by a battery 119. In order to lower the power consumption of the battery 119, the components of the padlock 600 may stay in a sleep state until the button 618 on the front plate is pressed, which activates the internal components of the padlock 600. The components of the padlock 600 may power down and go into a sleep state after use or a predetermined period of inactivity. This keeps the power consumption low for a longer battery life.

In response to the signal from the button 618, or periodically or in response to a predetermined trigger, the processor 110 may transition from a sleep state to an active state, and activate the internal components of the padlock 600, such as the RFID reader 102 or the Bluetooth system 104. The processor 110 may remain active until a predetermined period of inactivity, after which the processor 110 goes back to the sleep state. The padlock 600 may be configured to wake up periodically or based on certain triggers in order to communicate and receive instructions from the user (e.g., via Bluetooth, WiFi, or any other means).

FIG. 11 shows an exemplary padlock with LED indicators 1110 on the front cover of the padlock 600. The padlock 600 may include LED indicators 1110 or any other type of indicators. For example, the padlock 600 may include two (or more) LEDs to indicate a power-on/-off status, a Bluetooth connection status, a locked or unlocked state, and/or a low-battery state.

The padlock 600 may be locked and unlocked manually by an RFID device or by a Bluetooth device with an associated application. Alternatively, the padlock 600 may be locked and unlocked automatically by detecting the presence or absence of the user device 120 within a certain range of the padlock 600. For example, when a Bluetooth device comes close to the padlock 600, the Bluetooth system 104 in the padlock 600 may discover the presence of the Bluetooth device and obtain information from the Bluetooth device, and the padlock 600 may be automatically unlocked once it is determined that the Bluetooth device is a device authorized to access the area secured by the padlock 600. When the Bluetooth device goes out of a range, the Bluetooth system 104 in the padlock 600 discovers the absence of the Bluetooth device within the range, and the control system of the padlock 600 may automatically lock the padlock 600.

The embodiments disclosed with reference to FIGS. 7-11 may be applied to the padlock 200 shown in FIG. 2 as well.

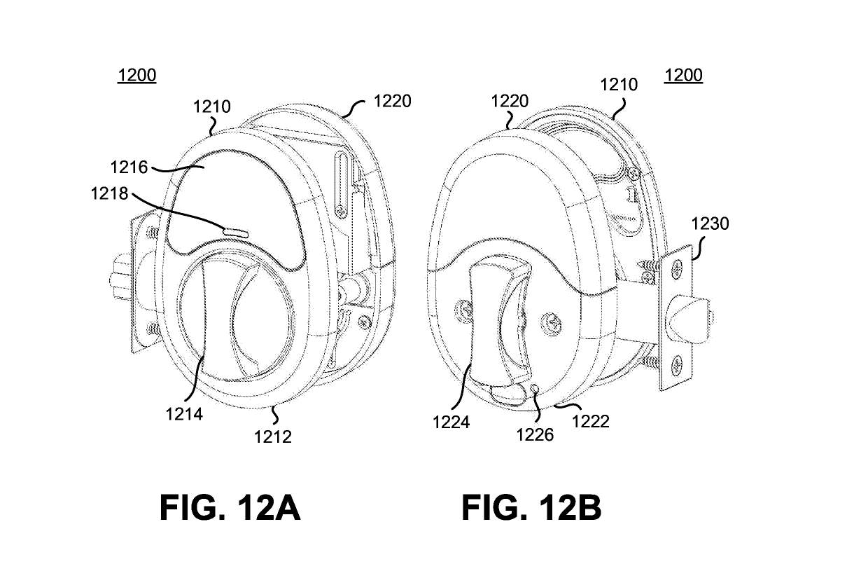

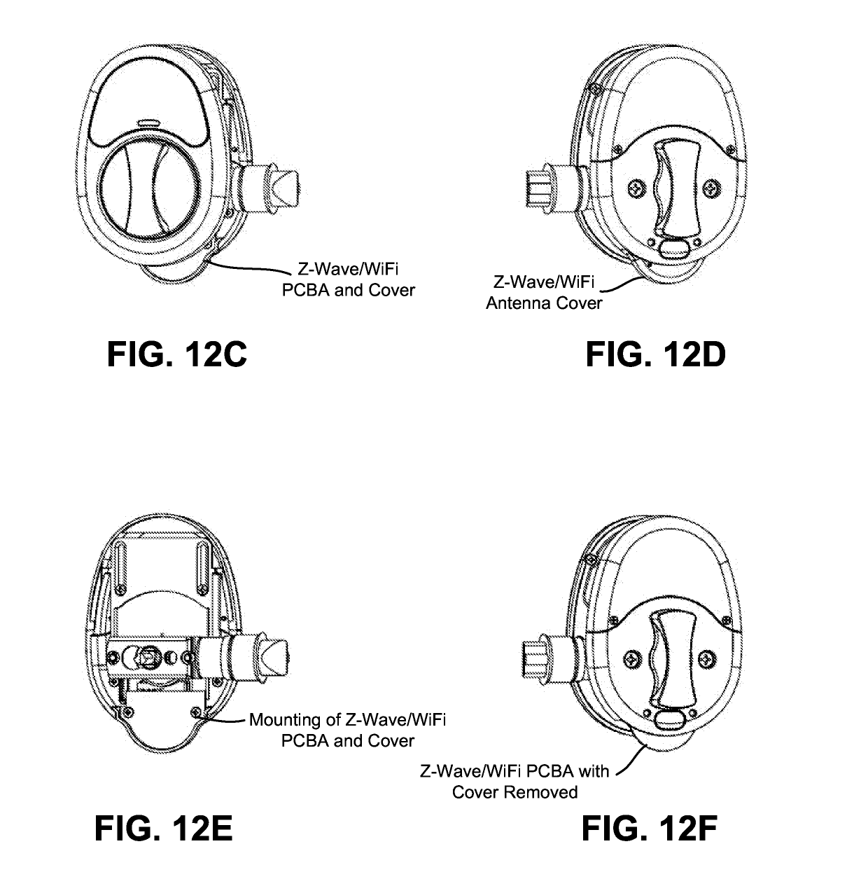

Embodiments for a door lock are disclosed hereafter. FIGS. 12A and 12B show an exemplary door lock seen from an external side and an internal side, respectively. The door lock 1200 includes an external unit 1210, an internal unit 1220, a door latch module 1230, a rotary connection module (not shown), and a locking mechanism 116. The external unit 1210 and the internal unit 1220 are installed on an external side and an internal side of the door, respectively. The external unit 1210 includes a housing 1212, an external handle 1214, a button 1216, and an external indicator 1218. The internal unit 1220 includes a housing 1222, an internal handle 1224, and an internal indicator 1226. The door latch module 1230 operates by the rotational force of the external handle 1214 or the internal handle 1224. The door lock 1200 may be locked by rotating the internal handle 1224 or the external handle 1214 to a locked position or by using the user device 120 (e.g., the RFID device or the Bluetooth device). The door lock 1200 may be unlocked by rotating the internal handle 1224 to an unlocked position or by using the user device 120. The door lock 1200 may include both an RFID reader 102 and a Bluetooth system 104 in a single device and either of these may be used to operate the mechanical locking mechanism 116 in the door lock 1200 by using an RFID/NFC key or a Bluetooth-enabled device. The lock control system may include additional wireless communication devices, such as Z-wave or WiFi, to send and receive authentication information or any other information. FIG. 12C shows a Z-wave/WiFi printed circuit board antenna (PCBA) and a cover. FIG. 12D shows a Z-wave/WiFi antenna cover. FIG. 12E shows a mounting of a Z-wave/WiFi PCBA and a cover. FIG. 12F shows a Z-wave/WiFi PCBA with the cover removed.

When a user presses the button 1216, the processor 110 activates the RFID reader 102 and the Bluetooth system 104, and obtains identifying information from a user device 120 and may unlock the door lock 1200 based on the identifying information. The door lock 1200 may also notify a person inside, for example through the Bluetooth system. This notification may be ringing a user's phone after establishing a Bluetooth connection with the user's phone.

The door lock 1200 may include a door proximity sensor to determine if the door is in the open or closed position. Alternatively, the door proximity sensor may be installed in the door frame or the door and may send the information to the door lock 1200.

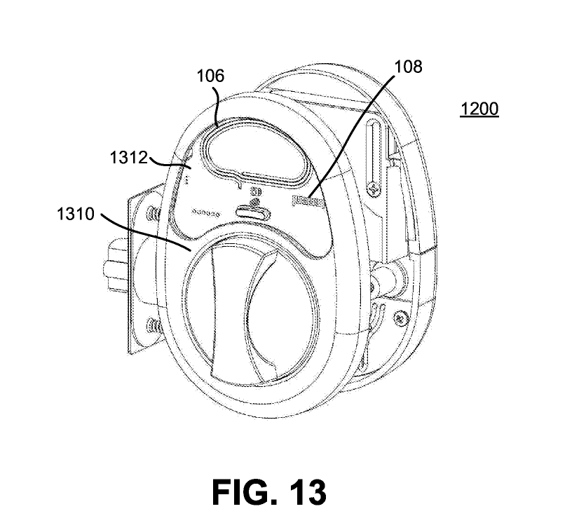

FIG. 13 shows an exemplary door lock with a front cover removed showing an inside of the door lock in accordance with one embodiment. A PCB on which the RFID antenna 106 and the Bluetooth antenna 108 are printed is installed in the housing 1212. In order to allow the Bluetooth signal or the RFID signal to pass through the metal housing of the door lock 1200, a cutout 1312 may be formed in the front plate 1310 as shown in FIG. 13. The cutout 1312 leaves the Bluetooth antenna 108 and the RFID antenna 106 on the PCB exposed. The cutout 1312 may be covered by a plastic cover or any non-metallic cover to protect the PCB and other components inside the door lock 1200 and for a better aesthetic appearance of the door lock 1200.

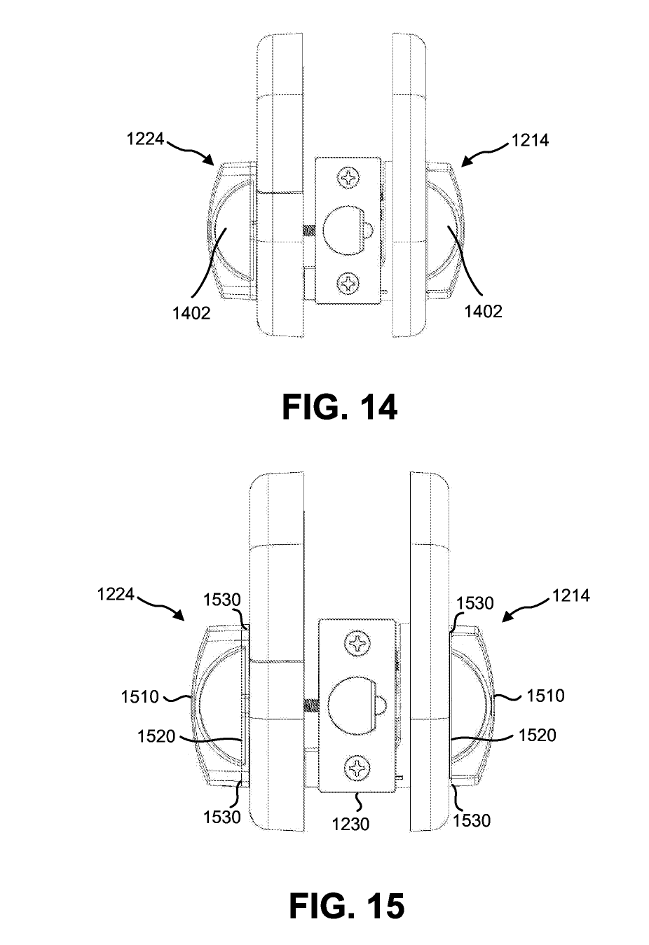

The external handle 1214 and the internal handle 1224 of the door lock 1200 may be a low-profile handle that allows the user to turn the handle and pull or push to open the attached door. Each handle 1214, 1224 has an opening 1402 as shown in FIG. 14. The opening 1402 may help the user grab the handle 1214, 1224 and operate the door.

FIG. 15 shows an exemplary two-part assembly of the external and internal handles 1214, 1224 of the door lock 1200. The external handle 1214 and/or the internal handles 1224 of the door lock may comprise a two-part assembly. Each assembly comprises a hand-grip part 1510 and a plate 1520. The hand-grip part 1510 is connected to the plate 1520 with two small screws 1530, and the plate 1520 is rotatably attached to the housing 1212, 1222 and connected to the rotary connection module to transfer the rotational force from the hand-grip part 1510 to the door latch module 1230. The small screws 1530 are designed to break apart before any other components of the door lock 1200 break when an excessive force is applied to the handle 1214, 1224. This ensures that the internal mechanism of the door lock 1200 is not damaged and the door lock 1200 remains secure even though an excessive force is applied to the handle 1214, 1224.

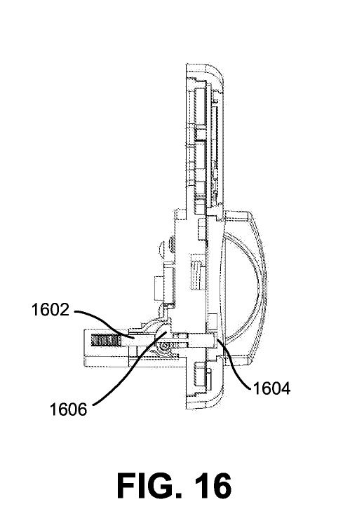

FIG. 16 shows a lock pin for locking the external handle. The external handle 1214 of the door lock 1200 may be locked into position by a lock pin 1602. The lock pin 1602 is extended, for example by a spring, into a locking hole 1604 formed into the external handle 1214 to lock the external handle 1214. The lock pin 1602 when extended into the locking hole 1604 prevents the external handle 1214 from rotating. To unlock the door lock, the lock pin 1602 is retracted from the locking hole 1604 by the servo motor 1606. Once the lock pin 1602 is removed from the locking hole 1604, the external handle 1214 may rotate freely.

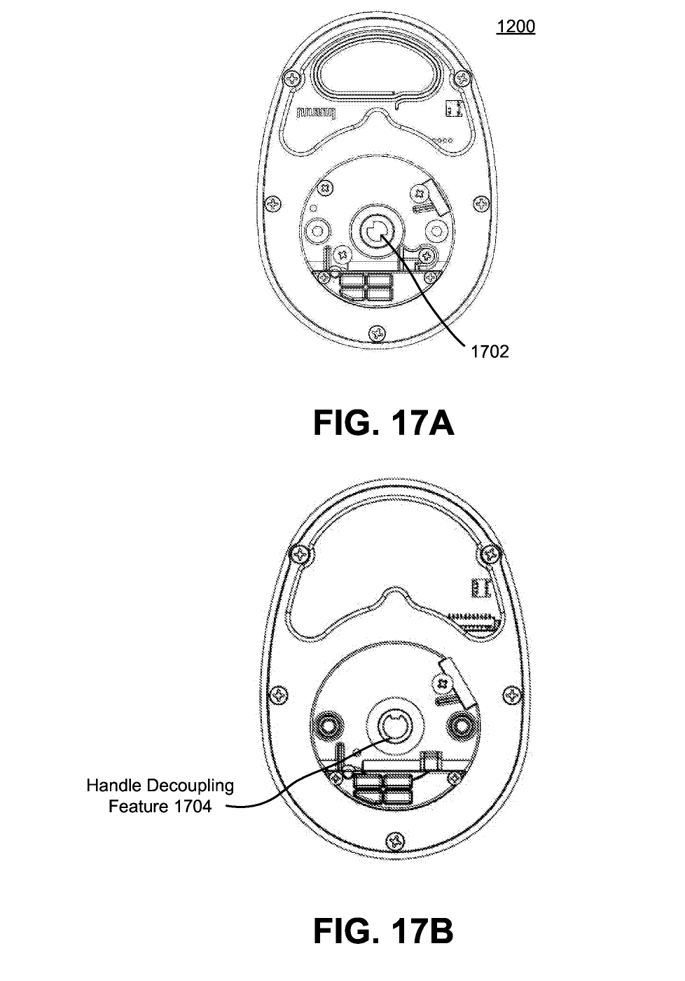

FIG. 17A shows a handle decoupling feature of the door lock. The external handle 1214 on the door lock may have a decoupling feature 1702 that allows the internal handle 1224 to turn and open the door without turning the external handle 1214. This allows the door lock to be opened from the inside even when the external handle 1214 is locked. It may be necessary for a door latch system to be opened from the inside (i.e., a secure side) at any time, for example in the event of a house fire, to allow those on the secure side to escape.

FIG. 17B shows a handle decoupling feature in accordance with another embodiment that allows for both left- and right-handed door opening. The handle decoupling feature 1704 allows the door lock to be opened from the inside even when the external handle 1214 is locked. It may be necessary for a door latch system to be opened from the inside (i.e., a secure side) at any time, such as in the event of a house fire, to allow those on the secure side to escape.

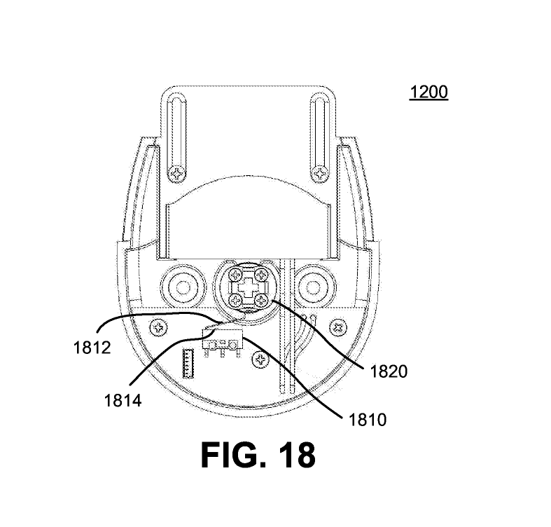

FIG. 18 shows an exemplary door lock with a door lock switch and a cam for automatic back unlock. The switch 1810 and the cam 1820 are configured to detect when the internal handle 1224 of the door lock 1200 has been actuated. For example, the cam 1820 rotates as the internal handle 1224 rotates. In a locked state, the switch 1810 is closed as the cam 1820 presses down the switch arm 1812 to the contact 1814. As the internal handle 1224 fully turns to the unlocked state, the cam 1820 also fully turns and the switch 1810 opens as the switch arm 1812 gets off of the contact 1814. The switch 1810 then notifies the processor 110 that the door has been opened from inside (i.e., the secure side). The user can set up the processor 110 to change the outside lock state to an unlocked state in such a case. This makes the door lock remain unlocked when the door is unlocked from inside, preventing the user from being locked out of a room upon exiting. For example, the user may exit the door to go outside from the secure side at night, while leaving the door unlocked so that the user can re-enter without a key.

The processor 110 may be set up in two modes to control the outside lock state. The first mode (persistent lock state) returns the external lock back to a locked state (with a time delay) after each entry. The second mode is a free access mode where after each access event the lock state is toggled to the opposite state.

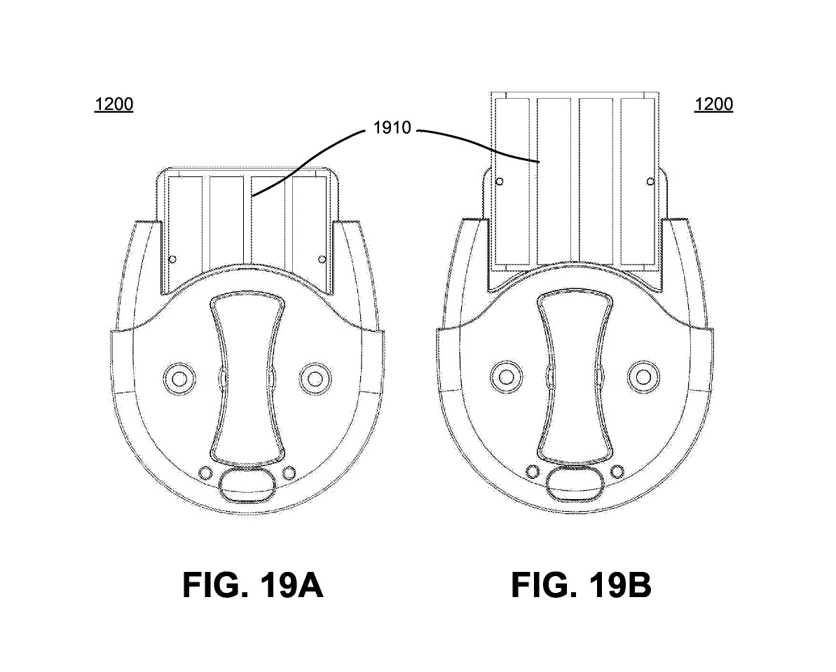

The door lock may have a sliding battery tray 1910 to install batteries. FIG. 19A shows a battery tray 1910 inserted into the door lock and FIG. 19B shows a battery tray 1910 slid out of the door lock. The battery provides operating powers to the internal components of the door lock 1200 such as the RFID reader 102, the Bluetooth system 104, etc. The batteries may be replaceable and rechargeable.

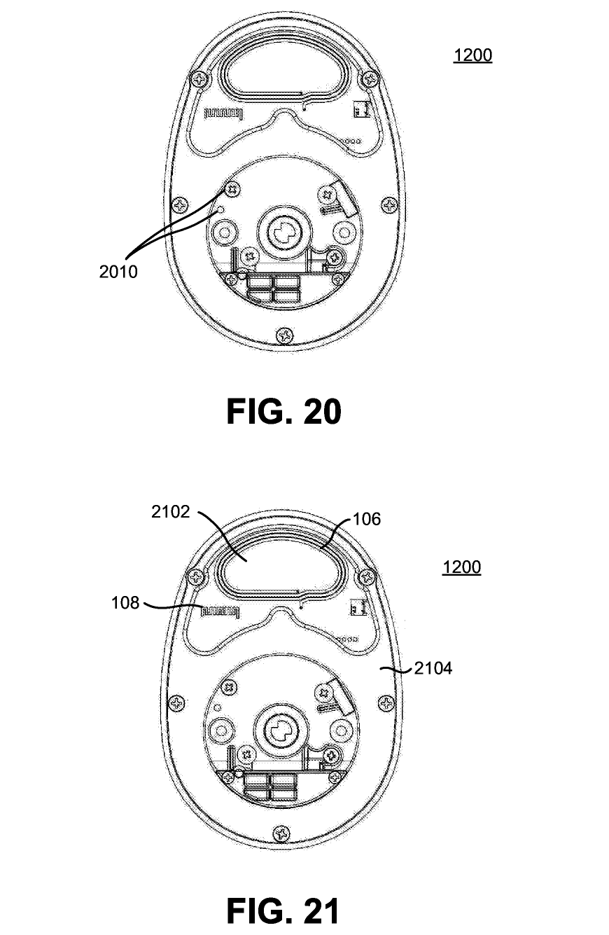

FIG. 20 shows an exemplary door lock handle turning prevention feature of a door lock. The door lock handle turning prevention feature 2010 (a screw and two holes in the example of FIG. 20) allows the door handle 1214, 1224 to turn in one way, either left or right (e.g., the screw allows the door handle 1214, 1224 to turn in one direction and prevents turning in the other direction). This ensures that the user would be able to turn the external handle 1214 or the internal handle 1224 in the correct direction. Doors and handles for opening the doors may be right handed or left handed. For example, if the door is a right-handed door opening in an inside direction, the latch may be required to turn clockwise for opening. The handle turning prevention feature 2010 allows the user to change the latch rotating direction by putting the screw in either the top hole or the bottom hole. FIG. 20 shows that the screw is installed in the top hole as an example.

The door lock 1200 may be configured to operate without the need for a motor-driven latch. This is a power-saving feature that allows the batteries to last much longer. For example, the door latch module 1230 may be a spring-loaded bolt latch in a deadbolt shape. The door latch module 1230 may have a catch mechanism so when the user opens the latch it is spring-loaded in the open position. When a signal is sent from the processor 110 to lock the door, the spring-loaded bolt latch is released to lock the door. A mechanical movement to lock or locking the external handle 1214 may release the spring-loaded bolt latch.

As explained above, a lock is typically made of metallic material, and placing an RFID antenna 106 and a Bluetooth antenna 108 in close proximity to, or surrounding these by, metal reduces their reading range and may completely disrupt their operation. This occurs because eddy currents are induced in the metal by the alternating magnetic field. The door lock 1200 may comprise both metallic and non-metallic components to reduce the interference with both RFID and Bluetooth signals. The components that are directly in front of, and behind, the RFID antenna 106 and the Bluetooth antenna 108 may be made of non-metallic material. FIG. 21 shows the inside of the external unit 1210 of the door lock seen from the back side of the external unit 1210. In order to reduce the interference with the RFID and Bluetooth antennas 106, 108, an opening 2102 may be formed in the metal plate 2104 behind the PCB where the RFID antenna 106 and the Bluetooth antenna 108 are located.

The internal components of the door lock 1200, such as the processor 110, the memory 112, the actuator 114, the RFID reader 102, the Bluetooth system 104, etc., may be powered by a battery 119. In order to lower the power consumption of the battery 119, the door lock 1200 may stay in a sleep state until a button 1216 on the front cover is pressed, which activates the internal components of the door lock 1200. The door lock 1200 powers down after use or a predetermined period of inactivity. This keeps the power consumption low for a longer battery life. In response to the signal from the button 1216, the processor 110 transitions from a sleep state to an active state, and transmits a signal to activate the RFID reader 102 or the Bluetooth system 104. The processor 110 may remain active until a predetermined period of inactivity, after which the processor 110 goes back to the sleep state.

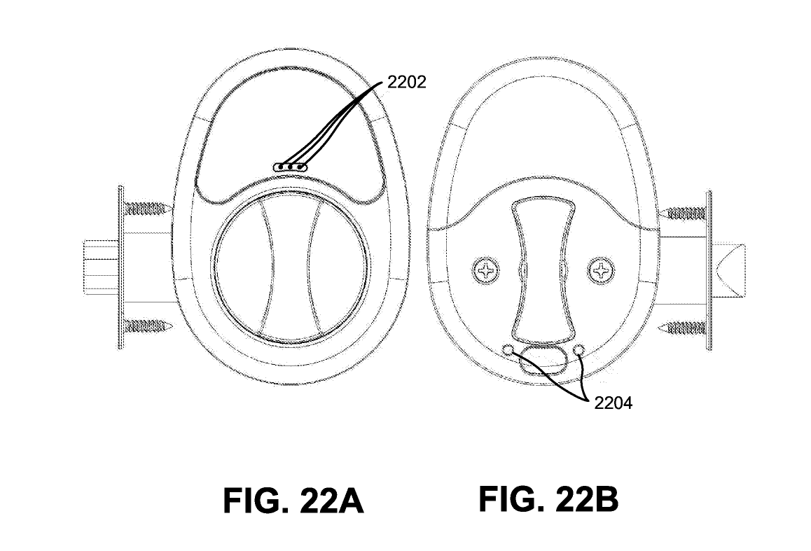

The door lock 1200 may include LED indicators or any other type of indicators. FIGS. 22A and 22B show external and internal units of an exemplary door lock with LED indicators, respectively. For example, the external unit 1210 of the door lock may include two (or more) LEDs 2202 to indicate a power-on/-off status, a Bluetooth connection status, a locked or unlocked state, and/or a low-battery state. The internal unit 1220 of the door lock may include one or more LEDs 2204 to indicate a locked or unlocked state.

The door lock 1200 may have an internal memory 112 to store data. The door lock 1200 may store the information of users that opened the lock, the time and date that the lock was opened, and any other relevant information. The door lock 1200 may have an application running on the processor 110. The application may store the user and time/date/location information when a lock is opened as well as any other information.

The door lock 1200 may be locked and unlocked manually by an RFID device or a Bluetooth device with an associated application. Alternatively, the door lock 1200 may be locked and unlocked automatically by detecting the presence or absence of the Bluetooth device within a certain range of the door lock 1200. For example, when a Bluetooth device comes close to the door lock 1200, the Bluetooth system 104 in the door lock 1200 may discover the presence of the Bluetooth device and obtain information from the Bluetooth device, and the door lock 1200 may be automatically unlocked if it is determined that the Bluetooth device is a device authorized to access the area secured by the door lock 1200. When the Bluetooth device goes out of a range, the Bluetooth system 104 in the door lock 1200 may discover the absence of the Bluetooth device within the range, and the door lock 1200 may be automatically locked.

A Bluetooth-enabled device (such as a phone) may connect to any Bluetooth-enabled device (such as a padlock, a door lock, or other locking devices having Bluetooth capability) it sees. Once a connection is established between Bluetooth-enabled devices, other devices may not connect to those devices. For example, in an environment with multiple (Bluetooth-enabled) phones and devices, connecting a particular phone to a particular Bluetooth-enabled device is very difficult.

In one embodiment, a Bluetooth-enabled device may connect to other Bluetooth-enabled devices it has previously connected to. A Bluetooth-enabled device may keep a list of addresses (such as MAC addresses) of the devices it has previously connected to. When the Bluetooth-enabled device searches for devices to connect to, it compares the addresses (e.g., MAC addresses) of each device with the list in its memory and connects to the device if there is a match.

New devices may be added to the list. Once a Bluetooth-enabled device is added to the list, the device may be connected to even in the presence of other devices. The addition of the Bluetooth-enabled device to the list may be done before the device is used in a crowded environment. Alternatively or additionally, a device with Bluetooth capability may connect to any Bluetooth-enabled device upon verification by the user (e.g., by entering that device's password).

A conventional lock may be opened and closed without any control. The owner and/or user of the lock might not know whether a location or material secured by the lock was accessed through the locking mechanism. In accordance with one embodiment, the lock may have a real time clock (RTC) that continually tracks time and date. The time and date may be updated by another device (e.g., a phone) when a connection is made between them. When the lock is opened, the identifying information of the user device (e.g., an RFID or NFC tag or a Bluetooth-enabled phone) used to open the lock is captured and the identifying information and the time information are recorded in a database in the memory of the lock. An application running on the processor 110 of the lock (e.g., a Bluetooth application) may then (with or without a password) provide these records to the owner or the user of the lock so that the owner or the user may know when and who accessed the locking mechanism.

Users may be given time-based access to a location secured by a lock. With the capabilities of a lock to keep track of time, the user or owner of the lock may set up the lock to allow a particular Bluetooth access code or RFID/NFC access code to be able to successfully access the lock at certain times. The lock firmware may also be programmed to give access based on the number of openings (e.g., one time, two times, etc.).

An administrator may program the lock to complete special administrative functions by scanning a special RF code that differs from a standard RF read code. An example of this would be to program a specific phone or Bluetooth password into many locks simply by reading a special RF-coded sequence through the standard RF interface.

Administrative rights over the lock 100 may be configured initially at the factory or subsequently by a user. In one embodiment, a fixed “master access code” may be programmed in the lock firmware that may not be erased or changed via Bluetooth, RFID, or the like. The locking system may be set up to allow administrator credentials via a particular protocol. For example, the lock 100 may be set up such that the first RFID code scanned by the lock 100 may become the master access code of the lock 100.

The lock 100 may be set up such that, for example after scanning an authorized device/card or receiving an authorized command, for example via RF communication, all factory default settings on the lock 100 may be recovered by pressing the program button or by sending appropriate credentials via RF interface (e.g., the Bluetooth system 104, etc.).

Alternatively, the lock 100 may be set up such that, for example after scanning an authorized device/card or receiving an authorized command, for example via RF communication, the authorization credentials may be customized by a user of the lock 100 by pressing the program button or by sending appropriate credentials, for example via RF interface. For example, the user may configure whether to use the real time clock, different RFID/NFC tag types, or the like.

The lock may be programmed to read one key or any number of keys. The lock may be configured to read one or several standard NFC protocols simultaneously depending upon user preference and/or available resources, such as memory space.

The capabilities to control the lock and store access records may be implemented in the lock locally. In this case, no connection to the web or cloud is needed to grant or reject access. The lock may have a database and may also have timing and decision-making capabilities within the lock itself. Alternatively, the lock may be provided with the capability of sending data over the cloud or web to enable remote access.

The lock may have the ability to automatically unlock, and turn itself on, when a connected Bluetooth device is present (with application and Bluetooth on) in a close range. This allows quicker access to the locks. However, there may be situations where the user or owner of the lock wants to grant specific validation before opening the lock. For example, a padlock on a gun case may be opened by a child if the parent is in another room and the child presses the padlock button, turning the lock off. In order to prevent the lock from inadvertently opening, the application may be set to require the user to grant access through the application for the lock to unlock. In this way the lock may not be opened just by turning the lock on (with a button press).

One or more of the features, functions, procedures, operations, components, elements, structures, etc. described in connection with any one of the embodiments described herein may be combined with one or more of the functions, procedures, operations, components, elements, structures, etc. described in connection with any of the other embodiments described herein, where compatible.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The claims are not limited to the specific implementations described above. Various modifications, changes and variations may be made in the arrangement, operation and details of the implementations described herein without departing from the scope of the claims.

What is claimed is:

1. A lock comprising:
a housing;
a locking mechanism to lock the lock; and
a lock control system including a radio frequency identification (RFID) reader and a Bluetooth system, wherein the lock control system is configured to actuate the locking mechanism based on identifying information obtained via the RFID reader or the Bluetooth system.

2. The lock of claim 1, wherein at least a portion of a front face of the housing in front of an RFID antenna and a Bluetooth antenna is made of non-metallic material.

3. The lock of claim 1, wherein a non-metallic isolation is provided between a wrap-around body and a bottom plate of the housing.

4. The lock of claim 1, wherein an RFID circuitry and a Bluetooth circuitry are printed on a printed circuit board (PCB), and a ground plane provided for the RFID circuitry and the Bluetooth circuitry has a slot where an RFID antenna and a Bluetooth antenna are located.

5. The lock of claim 1, wherein a cutout is provided on a front plate of the housing, leaving an RFID antenna and a Bluetooth antenna exposed.

6. The lock of claim 1, wherein the lock is a padlock including a shackle, wherein the housing includes a dowel pin channel for accommodating a dowel pin attached around a bottom of the shackle, and wherein the dowel pin channel is extended vertically with a horizontal extension at a top of the dowel pin channel such that the shackle can move vertically freely but cannot swivel until the shackle is fully extended out of the housing.

7. The lock of claim 1, further comprising a data connector for connecting to an external entity, wherein the data connector is accessed through a channel formed in the housing.

8. The lock of claim 1, wherein the locking mechanism includes a servo motor and a metal pin drivable by the servo motor, and wherein the metal pin is inserted into a notch formed into a shackle when in a locked state, and retracted from the notch when in an unlocked state.

9. The lock of claim 1, further comprising an indicator for indicating at least one of a power-on state, a Bluetooth connection status, a locked or unlocked status, or a low-battery state.

10. The lock of claim 1, wherein the lock is a door lock including an external unit and an internal unit installed outside and inside a door, respectively, wherein the external unit includes an external handle and the internal unit includes an internal handle, wherein the locking mechanism includes a servo motor and a metal pin drivable by the servo motor, and wherein the metal pin is extended into a locking hole formed into the external handle in a locked state to prevent the external handle from rotating, and the metal pin is extracted from the locking hole in an unlocked state.

11. The lock of claim 10, wherein the external handle and/or the internal handle are a two-part assembly including a hand-gripping part and a plate rotatably attached to the external unit or the internal unit, and wherein the hand-gripping part is attached to the plate with two screws such that the screws are configured to break before any other components of the lock break when an excessive force is applied to the hand-gripping part.

12. The lock of claim 10, further comprising:
a decoupling means configured to allow the internal handle to turn and open the door without operating the external handle.

13. The lock of claim 10, further comprising:
an automatic back unlock means configured to detect operation of the internal handle to unlock the door and leave the door unlocked.

14. The lock of claim 10, further comprising:
a door lock turning prevention means for allowing the external handle to rotate in a specific direction.

15. The lock of claim 1, wherein the lock stays in a sleep state until a button on a front plate of the lock is pressed by a user and returns to the sleep state after use or a predetermined period of inactivity.

16. The lock of claim 1, further comprising:
a memory for storing identifying information of users that opened the lock, and time and date information that the lock was opened.

17. The lock of claim 1, wherein the lock control system is configured to automatically unlock and lock the lock by detecting a presence or an absence of an RFID device or a Bluetooth device within a range of the lock.

18. The lock of claim 1, wherein the lock control system is configured to maintain a list of Bluetooth-enabled devices that it has previously connected to, and establish a connection with a Bluetooth-enabled device based on the list.

19. The lock of claim 1, further comprising:
a real time clock (RTC) configured to keep time and date information, wherein the lock control system is configured to keep records of identification of a device used to open the lock and time and date information when the lock is opened, and provide the records to a user or owner of the lock.

20. The lock of claim 19, wherein the lock control system is configured to provide time-based access to a location secured by the lock.

21. The lock of claim 1, further comprising:
a Global Positioning System (GPS) module for obtaining geolocation information of the lock, wherein the lock control system is configured to actuate the locking mechanism based on the geolocation information.

22. The lock of claim 1, wherein a master access code is programmed in a lock firmware.

23. The lock of claim 1, wherein factory default settings on the lock are recovered by pressing a program button or by sending a predetermined credential after scanning an authorized device or receiving an authorized command.

24. The lock of claim 1, wherein authorization credentials of the lock are customized by a user by pressing a program button or by sending a predetermined credential after scanning an authorized device or receiving an authorized command.

25. The lock of claim 1, wherein the lock is configured to read several near field communication (NFC) communications simultaneously.

26. The lock of claim 1, further comprising:
a sensor configured to detect when the lock is closed and send a signal to the lock control system indicating that the lock is closed.

27. The lock of claim 1, further comprising:
a bolt that is spring-loaded in an open state and released in response to a signal sent from the lock control system to lock the lock.
